(19) United States
(12) Patent Application Publication
(10) Pub. No.: US 2012/0120436 A1
(43) Pub. Date: May 17, 2012

(54) REMOTE PRINTING

(76) Inventors: Nirangan Damera-Venkata, Mountain View, CA (US); Nina Bhatti, Los Altos, CA (US); Eamonn O'Brien-Strain, San Francisco, CA (US); Nicholas P. Lyons, Sunnyvale, CA (US); Jerry J. Liu, Sunnyvale, CA (US); John Schettino, San Jose, CA (US)

(21) Appl. No.: 13/386,014

(22) PCT Filed: Jan. 29, 2010
(86) PCT No.: PCT/US10/22645

§ 371 Date: Jan. 19, 2012

(51) Int. Cl. G06F 3/12

(52) U.S. Cl. 358/1.13; 358/1.15

(57) ABSTRACT

A remote printing method includes extracting content of a device view caused to be displayed by a first device. The extracted content is communicated to a second device remote from the first device so that the second device can format the extracted content for printing.

### BACKGROUND

With mobile devices such as smart phones and PDAs (Personal Digital Assistants), users can access and view content from a multitude of web sites. Printing content from a mobile device can involve communicating an URL (Uniform Resource Locator) to the cloud, the cloud being a server or group of servers. Using the URL, the cloud retrieves content from a corresponding web site and sends that content to a networked printer for printing. This approach fails when the content viewed on the mobile device has been personalized by the web site based on a user profile or other data. In other words, the content retrieved for printing by the cloud will not contain the relevant elements displayed to the user of the mobile device. For example, the content displayed on a device may include a user's personal account information, while the content retrieved by the cloud using the URL may be a log-in screen asking for user credentials.

### DRAWINGS

FIG. 1 depicts an exemplary environment in which various embodiments may be implemented.

FIGS. 2-4 depict example and various physical and logical components for implementing various embodiments.

FIG. 5 is an exemplary flow diagram depicting steps taken to implement an embodiment.

FIG. 6 depicts an exemplary comparison between content viewed on a device and various versions of printed output according to embodiments.

FIG. 7 is an exemplary depiction of a web page format.

FIG. 8 is an exemplary depiction of the web page format of FIG. 7 with interspersed content.

FIGS. 9-11 are exemplary depictions of hierarchical structures according to an embodiment.

FIG. 12 is an exemplary depiction of extracted content according to an embodiment.

FIG. 13 is an exemplary depiction in which selected extracted content has been excluded according to an embodiment.

FIG. 14 is an exemplary depiction of formatted and printed content according to an embodiment.

### DETAILED DESCRIPTION

INTRODUCTION: Various embodiments described below were developed in an effort to enable remote printing from mobile devices. In particular, various embodiments allow a user to print, via the cloud, a rendering of content displayed on a mobile device. Where that content is personalized, content of a device view is extracted and communicated to the cloud where it is formatted for printing. Where the content is not personalized, a reference for accessing the content is communicated instead.

The term remote, as it refers to printing, is used to indicate that the printing initiated on a mobile device does not occur on the local network of the mobile device. For example, a user may, from a mobile device, request a print while at work, and the printing may occur at the user's home or other location remote from the local network to which the user is connected to at the time of the print request. In the context of a mobile device such as a cell phone, the local network is the communication link between the mobile device and a data service provider for the mobile device. Thus, there is no direct wired or wireless link between the mobile device and the printer. Rather, the printer is remote requiring an indirect link through the data service provider and one or more other servers.

As used herein, the term cloud refers to a server or a group of linked servers accessible via a network such as the internet. Content refers to text, images, and the like that can be retrieved via a network and presented for viewing by a user of a computing device. Personalized content refers to content generated or assembled based on data identifying a device, a user, or a group. Such data may, for example, be maintained by a server in a session cache, passed to the server using a cookie, or discerned through SSL (Secure Socket Layer) communications between the client and the server. For example, a user logged into a web site may send a request to a web server using an URL (Uniform Resource Locator). The server can generate and return content personalized based upon a cached session, a cookie provided with the request, or an SSL handshake. Thus a second device typically cannot use the same URL to retrieve the same personalized content.

The following description is broken into sections. The first, labeled “Environment,” describes an exemplary environment in which various embodiments may be implemented. The second section, labeled “Components,” describes examples of various physical and logical components for implementing various embodiments. The third section, labeled as “Operation,” describes steps taken to implement various embodiments, and the fourth section labeled “Examples” describes examples of formatting and printing content.

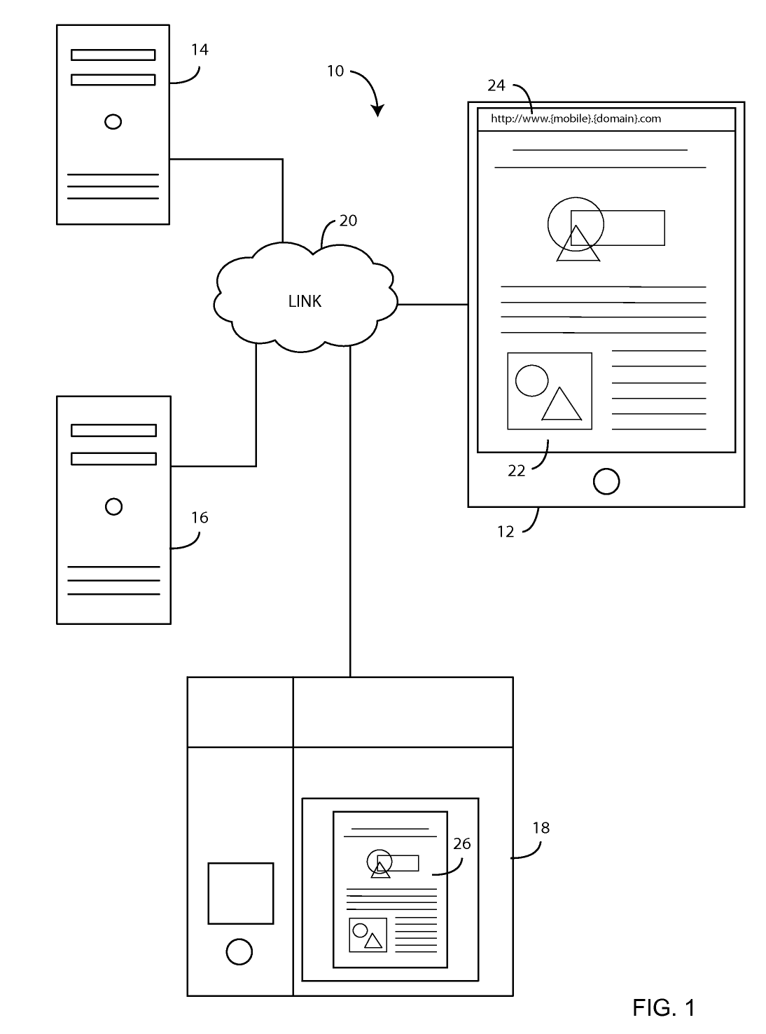

ENVIRONMENT: FIG. 1 depicts an exemplary environment 10 in which various embodiments may be implemented. Environment 10 is shown to include mobile device 12, servers 14, and 16, and printer 18. Mobile device 12 represents generally any mobile computing device capable communicating via a network to obtain content and then present a display or a view of that content to a user. Examples include smart phones, personal digital assistants, net-books, digital media players, and the like.

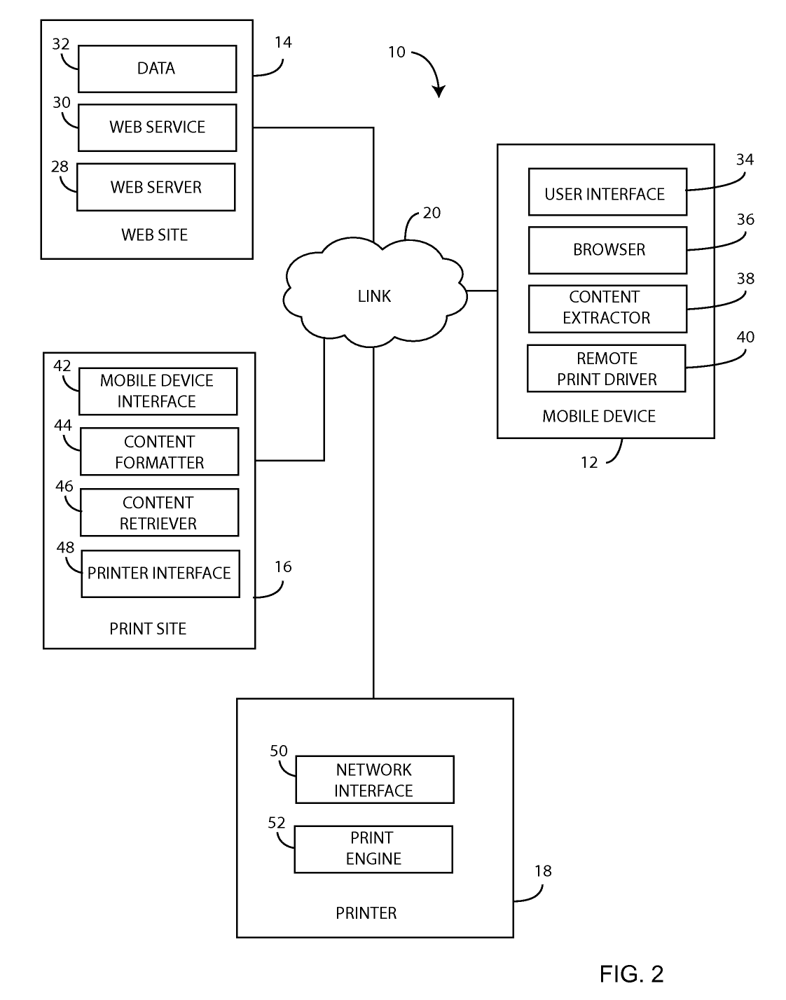

Each server 14 and 16 represents one or more computing devices capable of receiving and responding to network requests from mobile device 12. As discussed with reference to FIGS. 2-4 below, server 14 may be a web site designed to server requested content to mobile device 12. Server 16 may be a print site configured to receive print requests from mobile device 12 and, in response, cause printer 18 to produce printed output. Printer 18 represents generally any device configured to produce printed output at the direction of one of a server 14, 16 and mobile device 12.

Devices 12, 14, 16, and 18 are interconnected via link 20. Link 20 represents generally one or more of a cable, wireless, fiber optic, or remote connections via a telecommunication link, an infrared link, a radio frequency link, or any other connectors or systems that provide electronic communication. Link 20 may include, at least in part, an intranet, the Internet, or a combination of both. Link 20 may also include intermediate proxies, routers, switches, load balancers, and the like. The paths followed by link 20 between client devices 12, 14, 16, and 18 as depicted in FIG. 1 represent the logical communication paths between these devices, not necessarily the physical paths between the devices.

In the example of FIG. 1, mobile device 12 is shown presenting device view 22. Device view 22 includes content retrieved using reference 24. The content of device view 22 can include any combination of text, images, and other elements such as motion video. Utilizing reference 24, mobile device 12 sends a request to server 14 via link 20. In response, server 14 returns the content to mobile device 12. Mobile device 12 formats the content to generate device view 22. The content of device view 22 may or may not be personalized. As noted above, personalized content is generated or assembled based upon user or device identifying data. Further, the content may or may not be mobile content. Mobile content is content selected and formatted to be displayed by a mobile device. Various embodiments described below, allow a user to produce printed output 26 containing a rendition the content presented in device view 22 regardless of whether that content is mobile or personalized.

COMPONENTS: FIGS. 2-4 depict example and various physical and logical components for implementing various embodiments. Starting with FIG. 2, server 12 is shown as a web site including web server 28, web service 30, and data 32. Web server 28 represents generally any combination of hardware and programming capable of receiving and responding to requests originating from mobile device 12. Web service 30 represents generally any combination of hardware and programming capable of providing content for web server 28 to return to mobile device 12 in response to a request. Data 32 represents a collection of content and data utilized by web service 30 to generate content.

A request from mobile device 12 may include a reference. Web server 28 passes that reference to web service 30. Web service 30 accesses content associated with the reference from data 32, passing that content back to web server 28. Web server 28 returns the content to mobile device 12. The request from mobile device 12 may include a cookie or other user, group, device, or session identifying data. As a consequence, web service 30 may access data 32 and generate personalized content in response to the request. The request may also include a reference and an indication that it was received from a mobile device. Web service 30 may then access and pass back mobile content associated with the reference instead of content meant for a device such as a desktop or laptop computer.

Mobile device is shown to include user interface 34, browser 36, content extractor 38, and remote print driver 40. User interface 34 represents generally a display device capable of being used to present a visual display of content for viewing by a user. User interface 34 may also include a speaker and an input device enabling the user to enter commands. Such an input device may be implemented through one or more physical buttons, a touch screen interface, an audio sensor, and a video sensor.

Browser 36 represents generally any combination of hardware and programming configured to send a request to web site 12, to receive content returned in response, and to format the content for display of a device view by user interface 34. A device view is the graphical presentation of the content as configured to be view by a user of mobile device 12. As noted, a request may include user or device identifying data. Based on that data, the content returned may be personalized and may be mobile. Content extractor 38 represents generally any combination of hardware and programming configured to extract content of a device view caused to be displayed by user interface 34. In general, extracting content of the device view involves selecting some or all of the content elements included in the device view. In particular, extracting content of the device view may be accomplished by:
extracting a document object model defining the device view;
extracting the document object model and selecting content from the document object model;
extracting user selected content from the device view; and
extracting a bitmap image defining the device view.

Remote print driver 40 represents generally any combination of hardware and programming configured to communicate extracted content to print site 16 where the extracted content is to be formatted for printing. In particular, a user of mobile device 12 interacts with remote print driver 40 to indicate a desire to print. In a given implementation, remote print driver 40 responds by causing content extractor 38 to extract content of the device view. Remote print driver 40 obtains and communicates the extracted content to print site 16. In another implementation, remote print driver 40 first determines if the content to be extracted is personalized content. If it is, remote print driver 40 proceeds as described above. If not, remote print driver 40 obtains and communicates a reference to print site 16. That reference can then be used by print site 16 to obtain content from web site 14 and then format that content for printing. The content of the device view may be mobile content associated with the reference. However, print site 16 can, if appropriate, modify the reference to obtain non-mobile content that is better suited for printing from web-site 14.

Continuing with FIG. 2, print site 16 is shown to include mobile device interface 42, content formatter 44, content retriever 46, and printer interface 48. Mobile device interface 42 represents generally any combination of hardware and programming capable of receiving, from mobile device 12, extracted content of a device view caused to be displayed by mobile device 12. Mobile device interface 42 may receive the extracted content in the form of one of a document object model defining the device view, content selected from the document object model, content selected from the device view by a user, and a bitmap image defining the device view.

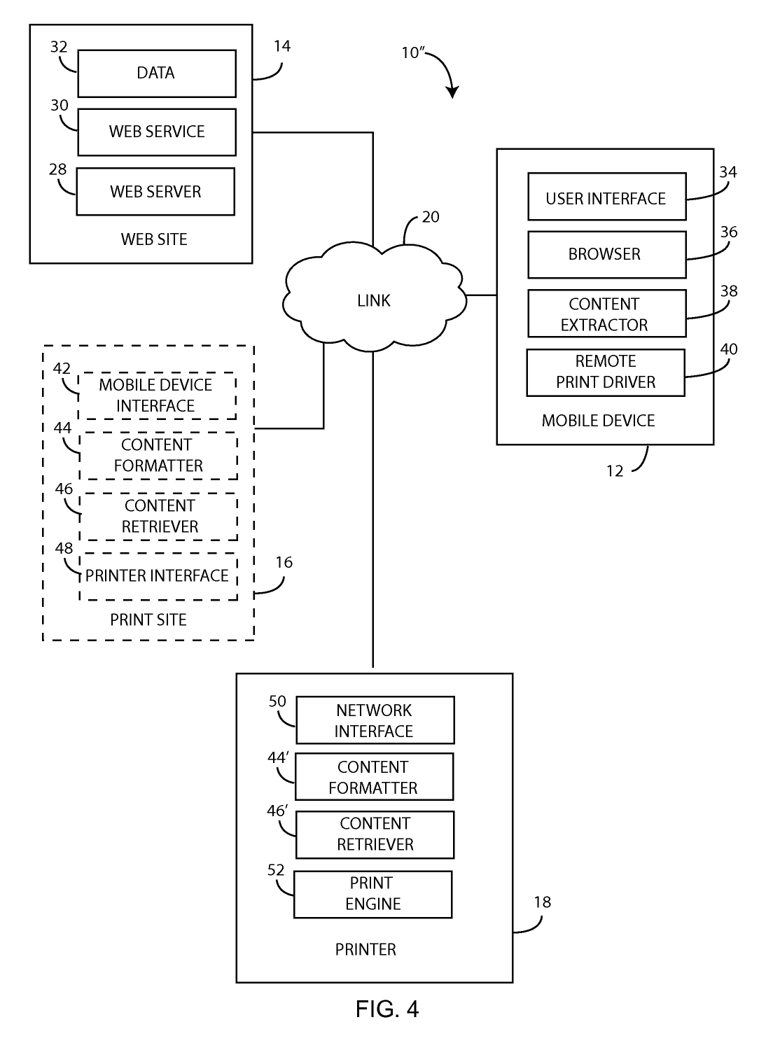

Content formatter 44 represents generally any combination of hardware and programming configured to format received content for printing. Such may include formatting the content, as-is, into a format compatible for printing by printer 18 or digital archiving. Exemplary formats include Post Script, PDL (Page Description Language), and PDF (Portable Document Format). Described in more detail below with respect to FIGS. 6-14, formatting can also include modifying the content to achieve a more desirable appearance. Such may involve adding content elements such as relevant advertisements when space on a printed page permits, eliminating an element when space is limited, rearranging elements to improve the aesthetic appearance of the printed page, and translating textual elements to a user's preferred language. While in many cases the content formatted for printing will ultimately be delivered to printer 18, in other cases it may initially, if not exclusively, be delivered to a server or other computing device for storage and later retrieval and display.

Content retriever 46 is responsible for retrieving additional content elements from web site 12 or another source as directed by formatter 44. Content formatter 44 then formats the content originally received along with the additional content later retrieved. When adding elements, content formatter 44 may analyze the content to identify a theme and then use that theme to identify and insert additional content elements relevant to the theme. For example, the content may include a key word or phrase indicating that travel from one place to another. Content formatter 44 may instruct content retriever 46 to retrieve one or more advertisements relevant to the route between the two locations. Content formatter 44 may also have knowledge of the location of printer 18 and cause content retriever 46 to retrieve advertisements or other information such as weather or an event schedule relevant to that location. Further, content formatter 44 may also identify a user who requested the print as well as a location of mobile device 12 based on an IP address, user profile, or other pertinent information. Content formatter 44 can use such information to cause content retriever 46 to retrieve content elements relevant to the user.

Content retriever 46 represents generally any combination of hardware and programming capable of retrieving content. Such content may be retrieved from web site 14 or from any of a multitude of sources accessible via link 20 (not shown). As noted above, mobile device interface 42 is responsible for receiving extracted content of a device view. Mobile device interface 42 may, in certain instances, receive a reference from mobile device 12 rather than extracted content. In such cases the reference is passed to content retriever 46. Content retriever 46 then utilizes the reference to retrieve associated content from web site 12. Content formatter 44 can then format the retrieved content for printing.

It is expected that the received reference, in some cases, may be a reference for retrieving mobile content. For example, non-mobile content may be accessed using the reference: “www.[website].com” while mobile content is retrieved using “www.mobile.[website].com.” The sub-domain “mobile” provides the indication to website 12 that mobile content is to be returned. Of course, other sub-domains and techniques may be used to identify the reference as being associated with mobile content. The mobile content retrieved using that mobile reference may be appropriate for display by mobile device 12. However, the same mobile content may not be ideal for print. Thus, content retriever 46 may examine the reference provided by mobile device 12 to determine if it is a mobile reference. Continuing with the above example, content retriever 46 may identify and remove a sub-domain such as “mobile” from the reference. Content retriever 46 can use the modified reference to retrieve non-mobile content that is then formatted by content formatter 44 for printing.

Printer interface 48 represents generally a combination of hardware and programming capable communicating a print job for the formatted content to printer 18. In particular, printer interface 48 may be responsible for first identifying printer 18 as the destination for the print job based on user preferences or other relevant considerations. Printer interface 48 may also be responsible for receiving communications from printer 18 and then using mobile device interface 42 to route the communications back to mobile device 12. Such communications may include an indication that the print job was received, the print job has been printed, any error messages, and any other information related to the print job.

Printer 18 includes network interface 50 and print engine 52. Network interface represents generally any combination of hardware and programming capable of receiving print jobs from print site 16 and communicating information related to received print jobs back to print site 16. Print engine 52 represents generally any combination of hardware and programming capable of producing printed output from print jobs received from print site 16. In particular, print engine 52 utilizes imaging material such as ink or toner to form a desired image on a print medium.

Moving to FIG. 3, another implementation is depicted in which actions taken by mobile device 12 in FIG. 2 are now taken by proxy site 54. Proxy site 54 represents one or more servers capable of acting as a proxy for mobile device 12 with respect to requests for content directed to web site 12. In the example of FIG. 3, proxy site 54 includes mobile device interface 56, web site interface 58, and display formatter 59. Mobile device interface 56 represents generally any combination of hardware and programming capable of intercepting or otherwise receiving a request for content from mobile device 12 that is directed to web site 14. Web site interface 58 represents generally any combination of hardware and programming capable of routing a request from mobile device 12 to web site 14 and receiving content returned in response.

Display formatter 59 represents generally any combination of hardware and programming capable of formatting content received by web site interface 58 into a device view for mobile device 12. Such a device view may take the form of a compressed bitmap representation of the content returned by web site 14. Mobile device interface 56 is then responsible for returning the formatted device view to mobile device 12. This approach provides for quicker load times for mobile device 12 since the majority of the processing takes place on proxy site 54.

Referring back to FIG. 2, the functions of content extractor 38 and remote print driver 40 may be moved to proxy site 54. In FIG. 3, proxy site 54 is shown to include content extractor 38′ and remote print driver 40′. Content extractor 38′ represents generally any combination of hardware and programming configured to extract content of a device view returned to mobile device 12. In this implementation, extracting content of the device view involves selecting some or all of the content elements returned from web site 12 that were used to generate the device view returned to mobile device 12. In particular, extracting content of the device view may be accomplished by:
extracting a document object model defining the device view;
extracting the document object model and selecting content from the document object model;
extracting user selected content from the device view; and
extracting a bitmap image defining the device view.

Remote print driver 40′ represents generally any combination of hardware and programming configured to communicate extracted content to print site 16 where the extracted content is to be formatted for printing. In particular, user of mobile device 12 interacts with remote print driver 40′ to indicate a desire to print. In a given implementation, remote print driver 40′ responds by causing content extractor 38 to extract content of the device view. Remote print driver 40′ obtains and communicates the extracted content to print site 16. In another implementation, remote print driver 40′ first determines if the content to be extracted is personalized content. If it is, remote print driver 40′ proceeds as described above. If not, remote print driver 40′ obtains and communicates a reference to print site 16. That reference can then be used by print site 16 to obtain content from web site 14 and then format that content for printing. In a given example, the content of the device view may be mobile content associated with the reference. However, the reference communicated to print site 16 allows print site 16 to obtain non-mobile content that is better suited for printing from web-site 14.

Moving to FIG. 4, another implementation is depicted in which actions taken by print site 16 are now taken by printer 18. In particular, Mobile device 12 communicates print requests to printer 18 rather than print site 16. Again, those print requests can include references and extracted content that are now received by network interface 50 of printer 18. In this example, printer 18 is shown to include content formatter 44′ and content retriever 46′. Content formatter 44′ represents generally any combination of hardware and programming configured to format received content for printing. Such may include formatting the content, as-is, into a format compatible for printing by printer 18. Exemplary formats include Post Script, PDL (Page Description Language), and PDF (Portable Document Format). Described in more detail below with respect to FIGS. 6-14, formatting can also include modifying the content to achieve a more desirable appearance when printed.

Content retriever 46′ represents generally any combination of hardware and programming capable of retrieving content. Such content may be retrieved from web site 14 or from any of a multitude of sources accessible via link 20 (not shown). As noted above, network interface 50 is responsible for receiving extracted content of a device view. Network interface 50 may, in certain instances, receive a reference from mobile device 12 rather than extracted content. In such cases the reference is passed to content retriever 46′. Content retriever 46′ then utilizes the reference to retrieve associated content from web site 12. Content formatter 44′ can then format the retrieved content for printing by print engine 52.

It is expected that the received reference, in some cases, may be a reference for retrieving mobile content. For example, non-mobile content may be accessed using the reference: “www.[website].com” while mobile content is retrieved using “www.mobile.[website].com.” The sub-domain “mobile” provides the indication to website 12 that mobile content is to be returned. Of course, other sub-domains and techniques may be used to identify the reference as being associated with mobile content. The mobile content retrieved using that mobile reference may be appropriate for display by mobile device 12. However, the same mobile content may not be ideal for print where a printed page has additional space. Thus, content retriever 46 may examine the reference provided by mobile device 12 to determine if it is a mobile reference. Continuing with the above example, content retriever 46′ may identify and remove a sub-domain such as “mobile” from the reference. Content retriever 46 can use the modified reference to retrieve non-mobile content that is then formatted by content formatter 44′ for printing by print engine 52.

In foregoing discussion, various components were described as combinations of hardware and programming. Such components may be implemented in a number of fashions. In one example, the programming may be processor executable instructions stored on tangible memory media and the hardware may include a processor for executing those instructions. Thus, certain elements operating on the same device may share a common processor and common memory media.

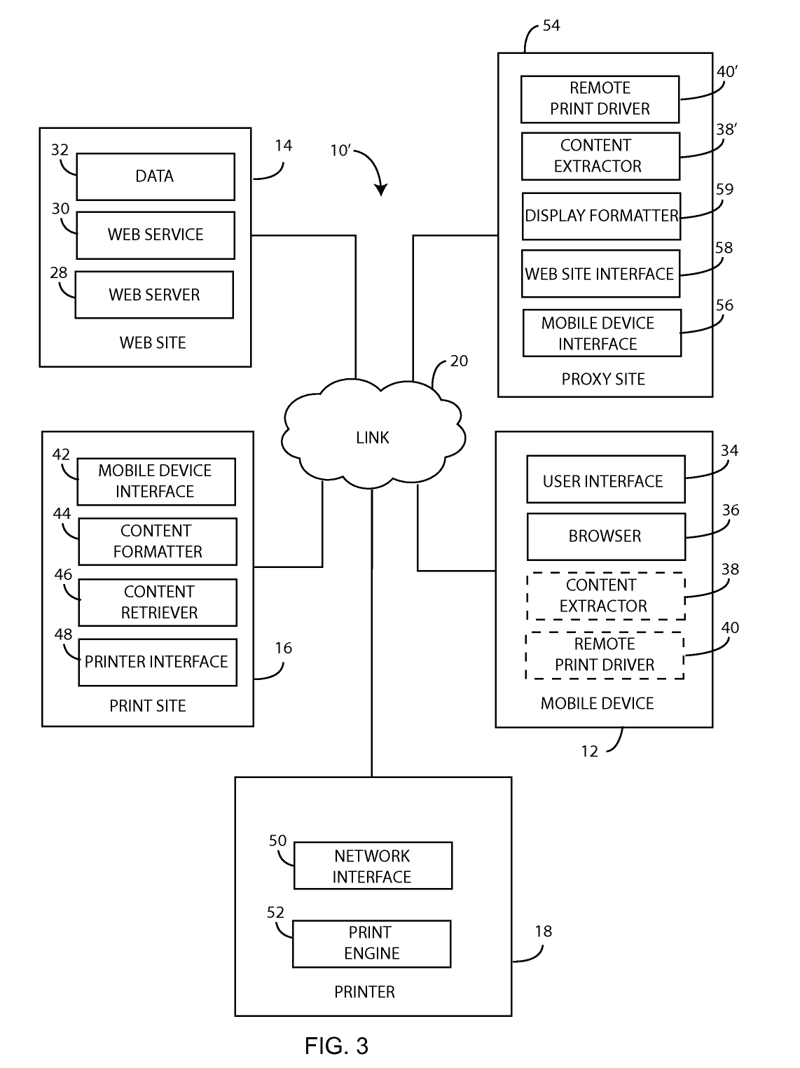

OPERATION: FIG. 5 is an exemplary flow diagram of steps taken to implement an embodiment. In discussing FIG. 5, reference may be made to the diagrams of FIGS. 1-4 to provide contextual examples. Implementation, however, is not limited to those examples. In the example of FIG. 5, the various steps are divided into blocks A, B, and C. Referring back to FIG. 2, the steps of block A are performed at mobile device 12, while in FIG. 3, those steps are performed at proxy site 54. The steps of Block B are, in FIGS. 2 and 3, performed at print site 16, while in FIG. 4, those steps are performed at printer 18. The step of block C is performed at printer 18.

Content for generating a device view is requested and received (step 60). A display of the device view is caused (step 62). As described, a device view is the graphical presentation of the content as configured to be viewed by a user of a device such as mobile device 12 of FIGS. 1-4. Referring to FIG. 2, steps 60 and 62 may be accomplished by browser 36 of mobile device 12. Referring to FIG. 3, steps 60 and 62 may be accomplished, at least in part, by web site interface 58 and display formatter 59.

It is determined if a user has requested a remote print (step 64). Until a positive determination is made in step 64, steps 60 and 62 may repeat. Upon a positive determination in step 64, a determination is made as to whether the content of the device view is personalized (step 66). As discussed above personalized content refers to content that was generated or assembled based on a profile or other user, group, or device identifying data. Referring back to FIGS. 2-4, steps 64 and 66 may be accomplished by remote print driver 40 or 40′ operating on mobile device 12 or proxy site 54 respectively.

The determination in step 66 may be made based upon user input. For example, a user, when issuing a remote print request may indicate whether or not the content is personalized. FIG. 6, discussed below, provides an example. Alternatively, the determination may be made based in a more automated fashion based upon an examination of the reference used to request the content in step 60. For example, a list of references for web sites that typically return personalized content may be maintained. Step 66 may include comparing the reference used in step 60 with that list—a positive determination occurring upon finding a match. Instead, the determination in step 66 may be based upon whether user, group, or device identifying data was required to obtain the content. Such may involve determining if the user engaged in a log-in procedure prior to the content being received in step 60.

Upon a determination in step 66 that the content is not personalized, the reference used to access the content in step 60 is obtained and communicated (step 68). With reference to FIG. 2-4, remote print driver 40 or 40′ obtains the reference. In FIGS. 2 and 3, the reference is communicated to print site 16. In FIG. 4, the reference is communicated to printer 18. The reference is received (step 70). Referring to FIGS. 2 and 3, mobile device interface 42 is responsible for receiving the reference. In FIG. 4, network interface 50 receives the reference. Using the reference, content is requested and received (step 72). As discussed above, the reference received in step 70 may be a reference for retrieving mobile content. Thus, step 72 can include examining the reference received in step 70 to determine if it is a mobile reference. If so, step 72 can also include manipulating the received reference to request associated non-mobile content.

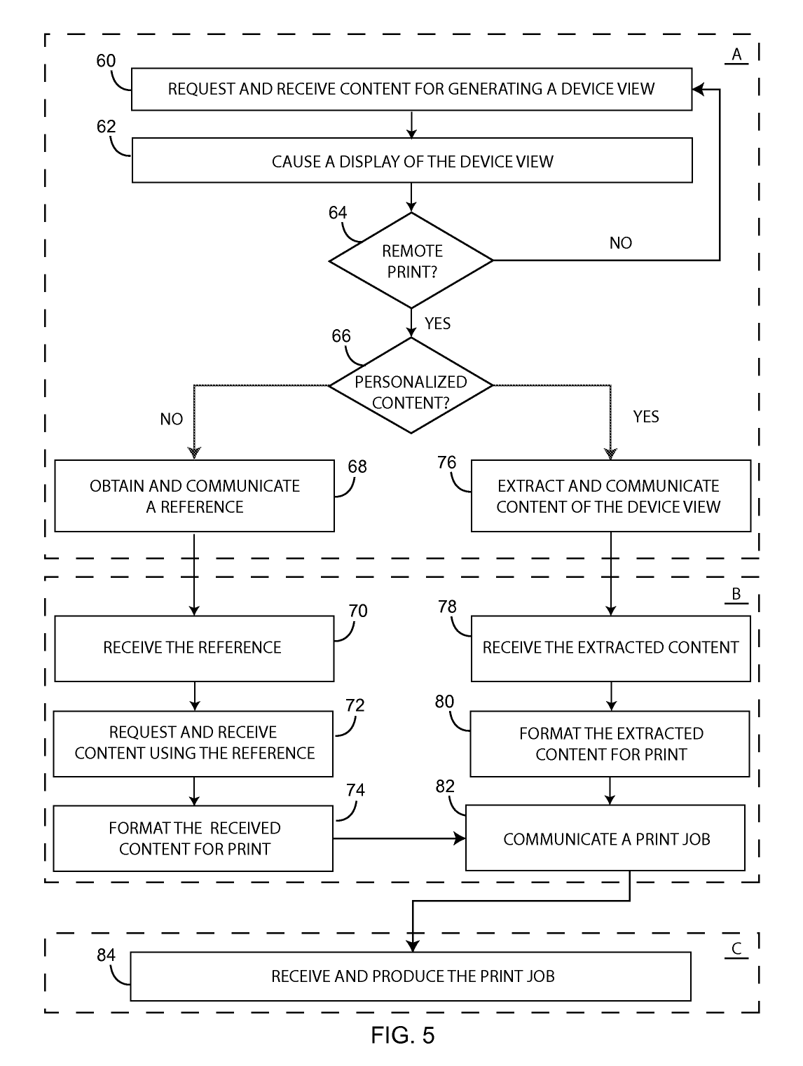

Referring to FIGS. 2-3, content retriever 46 is responsible for step 70 while in FIG. 4, the responsibility belongs to content retriever 46′. The received content is formatted for print (step 74). Referring to FIGS. 2-3, content formatter 44 is responsible for step 74. In FIG. 4, the responsibility for step 74 falls on content formatter 44′. An example in which content is formatted for print is described below in more detail with respect to FIGS. 7-14.

Referring back to step 66, upon a determination that the content is personalized, content of the device view is extracted and communicated (step 76). As discussed above, extracting content of the device view in step 66 can include one of:
extracting a document object model defining the device view;
extracting the document object model and selecting content from the document object model;
extracting user selected content from the device view; and
extracting a bitmap image defining the device view.
   The content is, in FIGS. 2-3, extracted by content extractor 38 or 38′ and is communicated to print site 16. In FIG. 4, the content is communicated to printer 18.

The extracted content communicated in step 76 is received (step 78) and formatted for print (step 80). Referring to FIGS. 2-3, mobile device interface 42 and content formatter 44 are responsible for steps 78 and 80 respectively. In FIG. 4, the responsibilities for steps 78 and 80 fall on network interface 50 and content formatter 44′ respectively. An example in which content is formatted for print is described below in more detail with respect to FIGS. 7-14.

A print job for the content formatted in step 74 or step 80 is communicated (step 82). Referring to FIGS. 2 and 3, printer interface 48 communicates the print job to printer 18. Referring to FIG. 4, step 82 occurs within printer 18 with content formatter 44′ communicating the print job to print engine 52. The print job is received and produced (step 84).

### EXAMPLES

FIGS. 6-14 are used to illustrate various examples. In particular FIG. 6 depicts an example illustrating how the printed output can differ based upon various factors and determinations. FIGS. 7-14 depict an example of how content, received in steps step 72 or step 78 of FIG. 5, may be formatted in step 74 or step 80 by removing particular elements to create a more aesthetic print.

Starting with FIG. 6, printed output can differ based upon: (1) the determination of whether a device view is determined to include personalized content in step 66 of FIG. 5; and (2) the manner in which retrieved or extracted content is formatted for print in steps 74 or 80 of FIG. 5. FIG. 6 depicts mobile device 12 displaying a device view 22 of mobile content retrieved using reference 24. A user has selected a printing icon 85 causing the display of a drop down menu with various print options. To aid in determining if device view 22 contains personalized content, those options include: (1) Print-Auto; (2) Print by Reference; and (3) Print by Value.

Selection of the “Print-Auto” option allows for an automatic determination of whether or not the content is personalized. As previously discussed, such a determination may be made based upon an analysis of a reference used to obtain the content of device view 22 or whether a log-in procedure was used to access the content. The latter two options allow user input to specify whether or not the content of device view 22 is personalized. Selection of the “Print by Reference” option is an indication that the content is not personalized, while selection of the “Print by Value” option is an indication that the content is personalized. Note that the particular names of the options are meant only to distinguish each option form the others.

Pages 86, 88, and 90 each represent a different version of an exemplary printed output of device view 22. Page 86 was produced following a determination that the content of device view 22 was not personalized. Pages 88 and 90 on the other hand were produced following a determination that the content was personalized. Referring first to page 86, reference 24 has been communicated from or on behalf of mobile device 12 following either a selection of the print by reference option or a selection of the auto-print option and subsequent determination that the content of device view 22 is not personalized. As noted, content of device view 22 is mobile content. Thus, the communicated reference is modified and used to retrieve non-mobile content that is formatted to generate a print job designed to produce page 86. In this example, that non-mobile content includes a representation 92 of device view 22 plus additional elements 94 that fill the printed page.

Referring to page 88, extracted content of device view 22 has been communicated from or on behalf of mobile device 12 following either a selection of the print by value option or a selection of the auto-print option and subsequent determination that the content of device view 22 is personalized. As discussed, the extracted content may be a bitmap representation of device view 22, a document object model defining device view 22, selected content from the document object model, or user selected content from device view 22. The extracted content is then formatted to generate a print job designed to produce page 88. In this example, the extracted content is formatted such that it includes only a representation 96 of device view 22.

Representation 96 of device view 22 in page 88 leaves a significant amount of blank space on page 88. Page 90 provides an example in which that blank space is utilized. As with page 88, extracted content of device view 22 has been communicated form or on behalf of mobile device 12 following either a selection of the print by value option or a selection of the auto-print option and subsequent determination that the content of device view 22 is personalized. The extracted content is then formatted to generate a print job designed to produce page 90. In this example, the extracted content is formatted such that it includes a representation 98 of device view 22. The extracted content has also been formatted to add elements 100. As discussed above, these additional elements 100 may include advertisements or other information relevant to the extracted content.

Moving to FIGS. 7-14, before being printed, the content received in step 72 or step 78 of FIG. 5 is first formatted in step 74 or step 80. Where that content is, for example, a web page or a DOM defining a device view, FIGS. 7-14 provide an example of how that content might be formatted to produce a more aesthetic print. The extracted or received content may be a web page or a representation of a web page used to convey information to a user. That information can include article content relevant to a user request as well as peripheral content such as web site identification, links, and miscellaneous advertisements. The article content can include information such as text and images related to a particular subject such as a news story, a recipe, or any other topic.

FIG. 7 is an exemplary format for web page 102. While the format shown is exemplary, it includes common sections such as article 104, header 106, column 108, and footer 110. Article section 104 includes article content such as text and images related to a particular subject of interest. Examples include, but are not limited to, news stories, building plans, and recipes. It may also include inline advertisements and other peripheral content not directly related to the article content. Header 106 typically includes data identifying a web site, navigation links, and often a banner advertisement. Column 108 can include advertisements and links related or unrelated to the content of article section 14. Footer 110 can include data identifying the web site, navigation links for the site and advertisements.

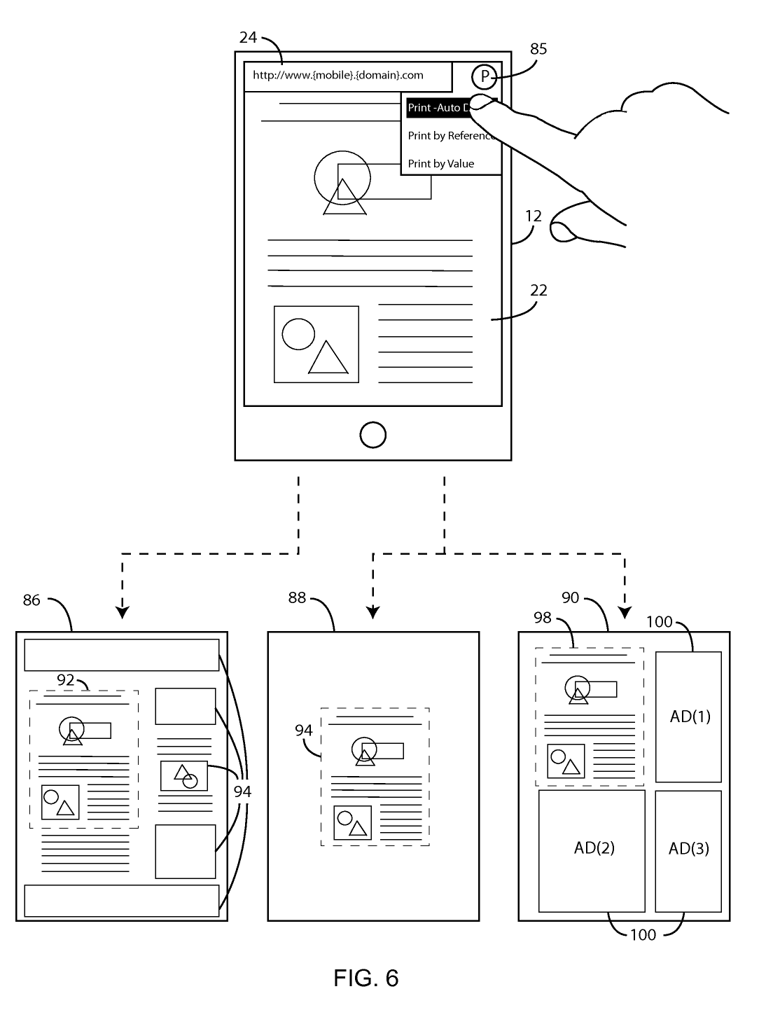

FIG. 8 is a depiction of the web page 102 of FIG. 7 with exemplary content interspersed within each section 104-110. Header 106 is shown to include banner ad 112, web site title 114, and web site link bar 116. Banner ad 112 represents generally an image serving as a link to another web page. Web site title 114 represents content such as text and images identifying the web site. Web site link bar 116 represents a group of links for navigating the identified web site. Typically, none of the content 112, 114, and 116 is directly related to the topic of the article content of section 104.

Article section 104 is shown to include title 118, text 120, image 122 inline ad 124, text 126, inline ad 128, text 130, and, in some cases, continuation link 132. Title 118 represents a title of the article content. Text 120, 126, and 130 represent the main text of the article content. Image 122 represents a picture or other graphical content that is part of the article content. Inline ads 124 and 128 represent links to other websites and are not necessarily related to title 118, text 120, 116, and 130, and image 122, and are peripheral to the article content. The article content may span one or more additional web pages. In such a case, continuation link 132 is included. Continuation link 132 represents a link to a subsequent web page that contains additional article content and often times appears at the end of article section 104 and includes the word “next” or “1” and “2.” That additional web page may or may not include another continuation link to yet another web page.

Column section 108 is shown to include column ad 134, related links 136, and column ad 138. Column ads 134 and 138 represent links to other websites and that may or may not be related to the topic of the article content. Related links 136 represent links to other web pages of the web sited that include other article content related to the article content of web page 102. Footer 110 is shown to include banner ad 140 and web site link bar 142. Banner ad 140 represents generally an image serving as a link to another web page. Web site link bar 142 represents a group of links for navigating the web site. Typically, none of the content 134-142 is directly related to the topic of the article content of section 104.

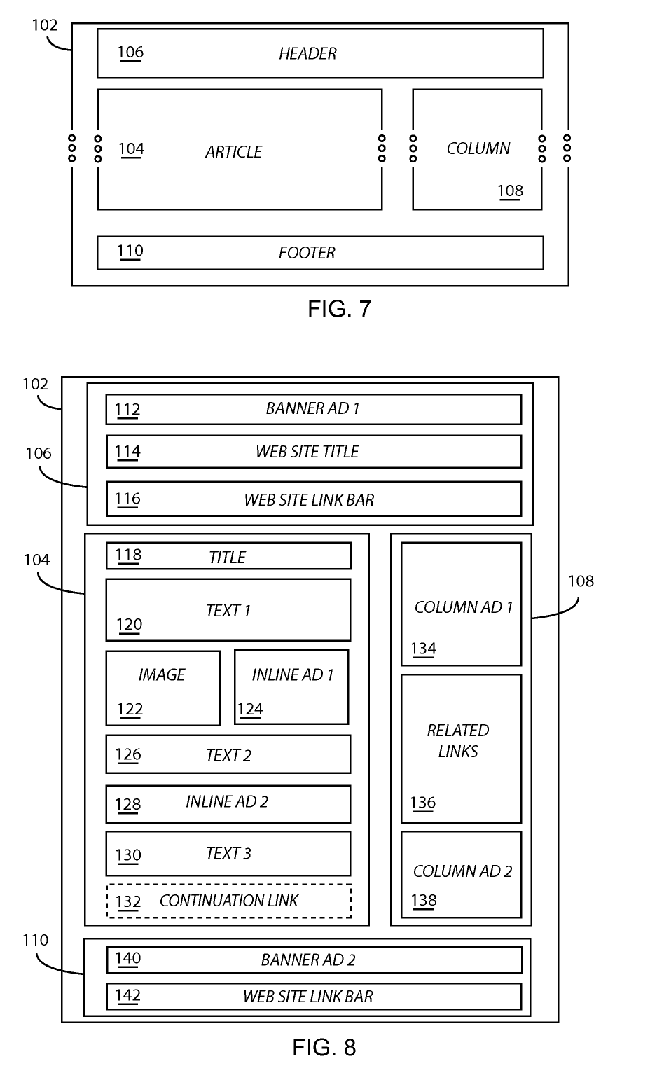

Using web page 102 of FIG. 8 as an example, various examples discussed below with respect to FIGS. 9-14 operate to format by automatically extracting the article content of section 104. Content from sections 106-110 is excluded. The extracted content can then be included in a print job. Of course web page 102 is used only as an example. The procedures discussed below work with a variety of web page formats.

Starting with FIG. 9, a hierarchical structure 144 of the subject web page is identified. Here the subject web page is web page 102 of FIG. 8. Such a hierarchical structure may be a DOM (Document Object Model) of the web page as depicted in FIG. 9 and expended upon in FIGS. 10 and 11. Structure 144 includes a plurality of hierarchically organized nodes. Node 146 is a root node that, in this example, identifies the web page language as HTML (Hyper-Text Mark-up Language). Note that, node 146 includes an opening tag “<HTML>” and a closing tag “</HTML>”. For purposes of efficiency in referring to the figures, the two tags are referred to as a singular node 146. In other contexts, each tag could be identified as a separate node on structure 144.

Root node 146 includes or otherwise encompasses child nodes 148 and 150. With respect to one another, nodes 148 and 150 are siblings at the same hierarchical level within structure 144. Node 148 corresponds to a head tag of the HTML code and includes child node(s) identified as head content 152. Head content 152 represents one or more child nodes containing content that is not directly visible to a viewer of a web page. Head content 152 can include an external links to items such as style sheets and JavaScript programs. Head content 152 also includes the title for the web page that appears in the top bar of a viewer's browser. Other elements may include a page description and key words.

Node 150 corresponds to the body tags of the HTML code and includes or otherwise encompasses content 154-160 corresponding, in this example, to sections 104-110 of web page 102. In other words body content 154-160 represents the various child nodes defining the content that can be seen when the web page is viewed. Header content 154 represents the various nodes defining the content of header section 106 of web page 102. Article content 156, expanded upon with respect to FIG. 10, represents various nodes defining the content of article section 104 of web page 102. Column content 158, expanded upon with respect to FIG. 11, represents various nodes defining the content of column section 108 of web page 102. Footer content 160 represents various nodes defining the content of footer section 110 of web page 102.

Referring now to FIG. 10, article content 156 includes node 162 representing an opening and closing tag corresponding to article section 104 of web page 102. Exemplary tags could include, but are not limited to <div>, <p>, and <br>. Tag 162 includes or otherwise encompasses child nodes 164-178. With respect to FIG. 8:
Node 164 corresponds to tags and content 164a for title 118;
Node 166 corresponds to tags and content 166a for text 120;
Node 168 corresponds to tags and content 168a for image 122;
Node 170 corresponds to tags and content 170a for inline ad 124;
Node 174 corresponds to tags and content 174a for text 126;
Node 174 corresponds to tags and content 74a for inline ad 128;
Node 176 corresponds to tags and content 176a for text 130; and
Node 178 corresponds to tags and content 178a for link 132.

Referring to FIG. 11, column content 158 includes node 180 representing an opening and closing tag corresponding to column section 16 of web page 102. Exemplary tags could include, but are not limited to <div>, <p>, and <br>. Tag 180 includes or otherwise encompasses child nodes 182-186. With respect to FIG. 8:
Node 182 corresponds to tags and content 182a for column ad 134;
Node 184 corresponds to tags and content 184a for related links 136; and
Node 186 corresponds to tags and content 186a for columns ad 138.

As noted above, the goal is to extract and print content from article section 104 excluding content from other sections 106-110. Another goal is to further pare advertisements and other peripheral information from the extracted article content before it is printed. To do so, structure 144 shown in FIGS. 9-11, is examined to identify potential article nodes. Article nodes, in the example of FIGS. 7-11, are those nodes that contain content that is part of article section 104. A potential article node is a node having a characteristic indicating a likelihood that the node contains content directly related to the main topic of a web page. In one example, a potential article node is a node containing text of a quantity that exceeds a threshold. That threshold can define a certain number of characters or words. From the identified potential article nodes, the node appearing first in the structure is identified as an article node. Content from the article node and sibling nodes are extracted, merged, and produced. In some cases content, such as advertisements, is excluded.

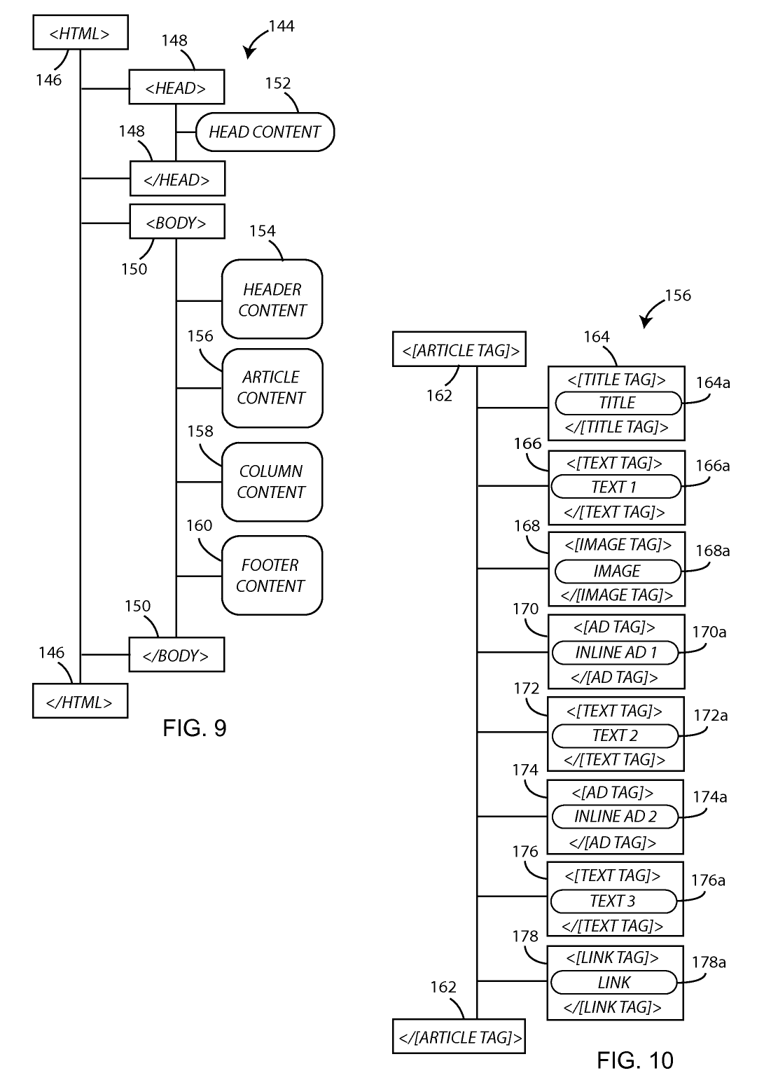

Moving to FIG. 12 (while referring back to FIGS. 9-11), presume text 166a of node 166, text 176a of node 176, and related links 184a of node 184 each includes text of a quantity that exceeds the threshold. Thus, each of nodes 166, 176, and 184 would be identified as a potential article node. Within structure 144, node 166 appears first and is thus of the highest rank of the identified potential article nodes. As a consequence, node 166, in this example, is selected as an article node. Nodes 164 and 168-178 are sibling nodes to node 166. In other words, nodes 164 and 168-178 are at the same hierarchical level as node 166 within structure 144.

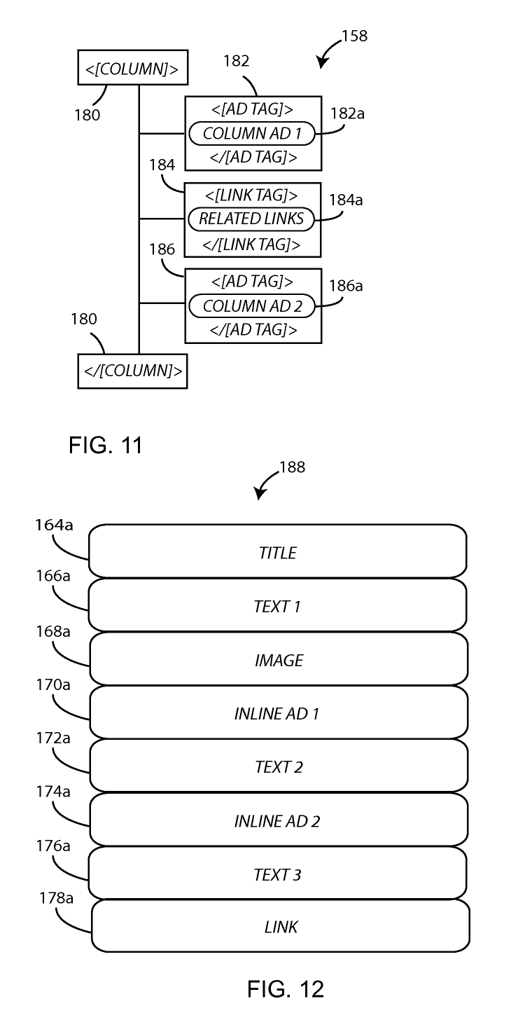

Content from identified article node 166 and sibling nodes 164 and 168-178 is extracted and merged as depicted by exemplary content structure 188 of FIG. 12. Before producing the content of structure 188, content peripheral to the text of the identified article node 166 is identified and excluded as depicted by exemplary content structure 190 of FIG. 13. Peripheral content can be identified in a number of manners. For example, peripheral content can include a link or an image with the text “advertisement”. Peripheral content can be a link with text of a quantity below a threshold value. For example a continuation link to a related page may simply include the word “next” or “continue” or “1” and “2”. Thus, in FIG. 13, content 170a, 174a, and 178a has been excluded from structure 190 in FIG. 13.

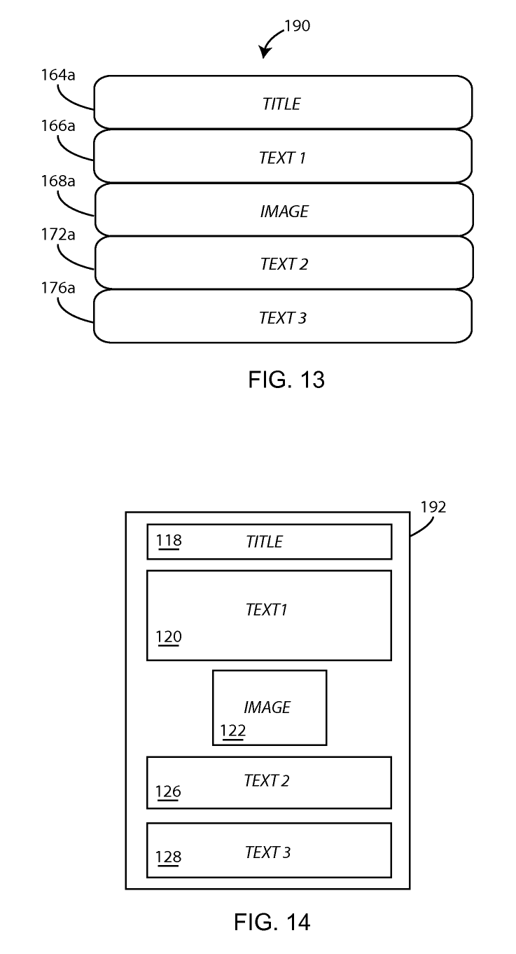

The content 164a, 166a, 168a, 174a, and 176a of content structure 190 can then be printed as depicted by produced content 100 of FIG. 14. In the example of FIG. 14, printed content 192 includes content directly related to the main topic of web page 102, that is, the topic of article section 104. Excluded from produced content 192 is content from sections 104-110 and peripheral content from section 104.

CONCLUSION: The diagrams of FIGS. 1-4 show the architecture, functionality, and operation of various embodiments. Various components illustrated in FIGS. 1-4 are defined at least in part as programs. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagram of FIG. 5 shows a specific order of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The diagrams of FIGS. 6-14 are used to depict various examples. FIG. 6 depicts an example illustrating how the printed output can differ based upon various factors and determinations. FIGS. 7-14 depict an example of how content received in steps step 72 or step 78 of FIG. 5 is may be formatted in step 74 or step 80 by removing particular elements to create a more aesthetic print. However, actual implementation is not so limited.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A remote printing method, comprising:
extracting content of a device view caused to be displayed by a first device; and
communicating the extracted content to a second device remote from the first device so that the second device can format the extracted content for printing.

2. The method of claim 1, wherein extracting content includes one of extracting a document object model defining the device view, extracting the document object model and selecting content from the document object model, extracting user selected content from the device view, and extracting a bitmap image defining the device view.

3. The method of claim 1, further comprising:
determining if the content of the device view is personalized content; and
upon a determination that the content is not personalized content, communicating a reference used to access the content to the second device so that the second device can retrieve content associated with the reference and format the retrieved content for printing; and
wherein extracting and communicating the extracted content comprises, extracting and communicating the content upon a determination that the content is personalized content.

4. The method of claim 3, wherein:
the second device is not a mobile computing device, the first device is a mobile computing device, and the content caused to be displayed is mobile content associated with the reference; and
communicating the reference comprises communicating the reference to the second device so that the second device can retrieve non-mobile content associated with the reference and format the retrieved non-mobile content for printing.

5. The method of claim 3, further comprising:
at the second device, receiving the extracted content if the content is determined to be personalized content and otherwise receiving the reference and retrieving content associated with the reference;
formatting for printing the received one of the extracted content and the retrieved content associated with the reference; and
communicating a print job to a printer for the formatted one of the extracted content and the retrieved content associated with the reference.

6. A remote printing method, comprising:
receiving, at a second device, extracted content of a device view caused to be displayed by a first device;
formatting the received content for printing; and
communicating a print job to a printer for the formatted content.

7. The method of claim 6, wherein receiving the extracted content includes one of receiving a document object model defining the device view, receiving content selected from the document object model, receiving content selected from the device view by a user, and receiving a bitmap image defining the device view.

8. The method of claim 6, wherein:
formatting the received content comprises retrieving additional content and formatting the received content with the additional content for printing;
communicating comprises communicating a print job to a printer for the received content formatted with the additional content.

9. The method of claim 8, wherein retrieving additional content comprises retrieving additional content relevant to one of the extracted content, the first device, and a user of the first device.

10. The method of claim 6, wherein:
receiving comprises receiving the extracted content if the extracted content of the device view is determined to be personalized content and otherwise receiving a reference and retrieving content associated with the reference;
formatting comprises formatting for printing the received one of the extracted content and the retrieved content associated with the reference; and
communicating comprises communicating a print job to a printer for the formatted one of the extracted content and the retrieved content associated with the reference.

11. The method of claim 10, wherein:
the second device is not a mobile computing device, the first device is a mobile computing device, and the extracted content of the device view caused to be displayed is mobile content associated with the reference; and
retrieving content associated with the reference comprises retrieving non-mobile content associated with the reference.

12. A system for remote printing comprising:
a content extractor configured to extract content of a device view caused to be displayed by a first device; and
a remote print driver configured to communicate the extracted content to a second device remote from the first device so that the second device can format the extracted content for printing.

13. The system of claim 12, wherein the content extractor is configured to extract content includes by one of extracting a document object model defining the device view, extracting the document object model and selecting content from the document object model, extracting user selected content from the device view, and extracting a bitmap image defining the device view.

14. The system of claim 12, wherein:
the remote printer driver is configured to determine if the content to be extracted is personalized content;
the content extractor and remote print driver are configured to extract and communicate the content only upon a determination that the content to be extracted is personalized content;
upon a determination that the content is not personalized content, the remote printer driver is configured to obtain and communicate a reference used to access the content to the second device so that the second device can retrieve content associated with the reference and format the retrieved content for printing.

15. The system of claim 14, wherein:
the second device is not a mobile computing device, the first device is a mobile computing device, and the content caused to be displayed is mobile content associated with the reference; and
the remote printer driver is configured to communicate the reference to the second device so that the second device can retrieve non-mobile content associated with the reference and format the retrieved non-mobile content for printing.

16. A remote printing system, comprising:
a device interface configured to receive extracted content of a device view caused to be displayed by a first device;
a content formatter configured to format, at a second device, the received content for printing; and
a printer interface configured to communicate a print job to a printer for the formatted content.

17. The system of claim 16, wherein the device interface and the content formatter are configured to receive and format the extracted content, where the extracted content is in the form of one of a document object model defining the device view, content selected from the document object model, content selected from the device view by a user, and a bitmap image defining the device view.

18. The system of claim 16, further comprising a content retriever configured to retrieve additional content and wherein:
the content formatter is configured to format the received content with the additional content for printing;
the printer interface is configured to communicate a print job to a printer for the received content formatted with the additional content.

19. The system of claim 18, wherein the content retriever is configured to retrieve additional content relevant to one of the extracted content, the first device, and a user of the first device.

20. The system of claim 16, wherein the device interface is configured to receive the extracted content if the extracted content of the device view is determined to be personalized content and otherwise to receive a reference, the system further comprising a content retriever configured to retrieve content associated with the reference, and wherein:
the content formatter is configured to format for printing the received one of the extracted content and the retrieved content associated with the reference; and
the printer interface is configured to communicate a print job to a printer for the formatted one of the extracted content and the retrieved content associated with the reference.

21. The system of claim 20, wherein:
the second device is not a mobile computing device, the first device is a mobile computing device, and the extracted content of the device view caused to be displayed is mobile content associated with the reference; and the content retriever is configured to retrieve non-mobile content associated with the reference.
